(19) United States
(12) Patent Application Publication
(10) Pub. No.: US 2017/0299088 A1
(43) Pub. Date: Oct. 19, 2017

(54) BYPASS VALVE AND EXPANDER UNIT HAVING A BYPASS VALVE

(71) Applicant: Robert Bosch GmbH, Stuttgart (DE)

(72) Inventors: Klaus-Juergen Rau, Marbach (DE); Tobias Haug, Stuttgart (DE)

(21) Appl. No.: 15/485,565

(22) Filed: Apr. 12, 2017

(30) Foreign Application Priority Data
Apr. 14, 2016 (DE) 102016206272.7

(51) Int. Cl. F16K 49/00; F01N 5/02; F16K 11/07; F16K 31/06

(52) U.S. Cl. CPC F16K 49/005; F16K 31/0675; F01N 5/02; F16K 11/07

(57) ABSTRACT

A bypass valve having a valve housing and a slide-longitudinally movable in the valve housing. An inlet duct, an outlet duct and a further outlet duct are formed in the valve housing. A closing body (35a) of the slide interacts, by way of its longitudinal movement, with a slide seat formed in the valve housing and thereby opens and closes a first hydraulic connection between the inlet duct and the outlet duct. A further closing body of the slide interacts, by way of its longitudinal movement, with a further slide seat formed in the valve housing and thereby opens and closes a second hydraulic connection between the inlet duct and the further outlet duct. The longitudinal movement of the slide is controlled by way of an electromagnetic actuator. The bypass valve has a cooling device for cooling the actuator.

### BACKGROUND OF THE INVENTION

The invention relates to a bypass valve and to an expander unit having a bypass valve. The expander unit and the bypass valve may be used in particular in a waste-heat recovery system of an internal combustion engine.

Expander units having a bypass valve are known from the prior art.

A known expander unit comprises an expansion machine, a bypass valve and a bypass line. It is thus possible, as required, for a working medium to be supplied to the expansion machine or conducted past said expansion machine through the bypass line. A bypass valve of said type is known for example from the application DE 10 2014 224979 A1, which does not constitute a prior publication. The known bypass valve has a valve housing with a slide arranged in longitudinally movable fashion therein. An inlet duct, an outlet duct and a further outlet duct are formed in the valve housing. A closing body of the slide interacts, by way of its longitudinal movement, with a slide seat formed in the valve housing and thereby opens and closes a first hydraulic connection between the inlet duct and the outlet duct. A further closing body of the slide interacts, by way of its longitudinal movement, with a further slide seat formed in the valve housing and thereby opens and closes a second hydraulic connection between the inlet duct and the further outlet duct. The longitudinal movement of the slide is in this case controlled by an actuator.

During the operation of a waste-heat recovery system, it is commonly the case that very high temperatures prevail, with the result that many of the components of the waste-heat recovery system, in particular the expander unit, are subjected to high temperatures. Specifically in the case of the actuator of the bypass valve, this can lead to a functional impairment.

### SUMMARY OF THE INVENTION

In relation thereto, the bypass valve according to the invention exhibits lower temperature loading and thermomechanical loading of the actuator. In this way, firstly, the functionality of the bypass valve is made more robust, and, secondly, the service life of the bypass valve is also lengthened.

For this purpose, the bypass valve comprises a valve housing and a slide which is arranged in longitudinally movable fashion in the valve housing. An inlet duct, an outlet duct and a further outlet duct are formed in the valve housing. A closing body of the slide interacts, by way of its longitudinal movement, with a slide seat formed in the valve housing and thereby opens and closes a first hydraulic connection between the inlet duct and the outlet duct. A further closing body of the slide interacts, by way of its longitudinal movement, with a further slide seat formed in the valve housing and thereby opens and closes a second hydraulic connection between the inlet duct and the further outlet duct. The longitudinal movement of the slide is controlled by way of an electromagnetic actuator. The bypass valve has a cooling device for cooling the actuator.

The cooling device cools the actuator during the operation of the bypass valve. Overheating of the actuator and resulting possible functional impairment are thereby avoided. The functionality of the actuator is thus robust even at high temperatures. At the same time, the thermomechanical loading of the entire bypass valve is minimized by way of the cooling device.

In advantageous refinements, the cooling device has a cooling housing, wherein a cooling inlet, a cooling outlet and a cooling chamber are formed in the cooling housing. In this way, the cooling device can be flowed through by cooling medium during the operation of the bypass valve, and thus the heat that is introduced into the bypass valve can be dissipated in a highly efficient manner.

The cooling chamber is advantageously arranged so as to radially surround the actuator. In this way, the actuator is cooled in targeted fashion. In particular, in this way, a magnet coil of the electromechanical actuator is not exposed to damaging high temperatures. The functionality of the actuator is thus maintained even at very high operating temperatures.

In advantageous embodiments, the cooling housing has a partition, wherein the partition separates the actuator from the cooling chamber in medium-tight fashion. In this way, it is ensured that the actuator does not come into contact with the cooling medium, which may be highly aggressive. Thus, the actuator itself does not need to be designed to be resistant to chemicals.

In an advantageous refinement, it is provided here that the partition is formed from a non-magnetic material. In this way, the functionality of the actuator is not adversely affected by the partition or by the housing.

In advantageous embodiments, the cooling housing has a casing, wherein the casing surrounds the rest of the cooling housing or the cooling chamber, and wherein the casing is formed from a thermal insulation material. In this way, the cooling chamber is thermally insulated with respect to the further surroundings, for example with respect to an engine bay. This is advantageous in particular if the further surroundings are at a very high temperature, in particular at a higher temperature than the cooling medium.

In advantageous embodiments, the slide valve is arranged in an expander unit. The expander unit comprises an expansion machine, a bypass line and the bypass valve. The bypass line is arranged parallel to the expansion machine, wherein the bypass valve controls the mass flow of a working medium to the expansion machine and to the bypass line. The expansion machine is connected to the outlet duct of the bypass valve, and the bypass line is connected to the further outlet duct. The expansion machine is subjected to high temperature loading during operation. Therefore, the bypass valve according to the invention is very highly suitable as a bypass valve with respect to an expansion machine. The expansion machine and the bypass valve are advantageously arranged in a housing in order to save structural space. Accordingly, the temperature loading of the bypass valve is high. By way of the cooling device, the temperature, in particular in the region of the actuator, is however capped at a relatively low level, such that the actuator is not subject to any functional impairment.

In advantageous refinements, the expander unit is arranged in a waste-heat recovery system of an internal combustion engine. The waste-heat recovery system has a circuit which conducts a working medium. The circuit comprises, in a flow direction of the working medium, a pump, an evaporator, the expander unit and a condenser.

To realize a high level of efficiency of the waste-heat recovery system, it is necessary for the working medium to be delivered to the expansion machine, or conducted past said expansion machine through the bypass line, as required. Here, the operating states may change very quickly. A robust, fast actuation of the bypass valve, and a corresponding switching characteristic, are accordingly important for the efficiency of the waste-heat recovery system.

### BRIEF DESCRIPTION OF THE DRAWINGS

FIG. 1 schematically shows a waste-heat recovery system, with only the regions of importance being illustrated.

FIG. 2 schematically shows a bypass valve in longitudinal section, with only the regions of importance being illustrated.

FIG. 3 shows a detail of a bypass valve, with only the regions of importance being illustrated.

FIG. 4 shows a flow geometry of a cooling device of the bypass valve.

### DETAILED DESCRIPTION

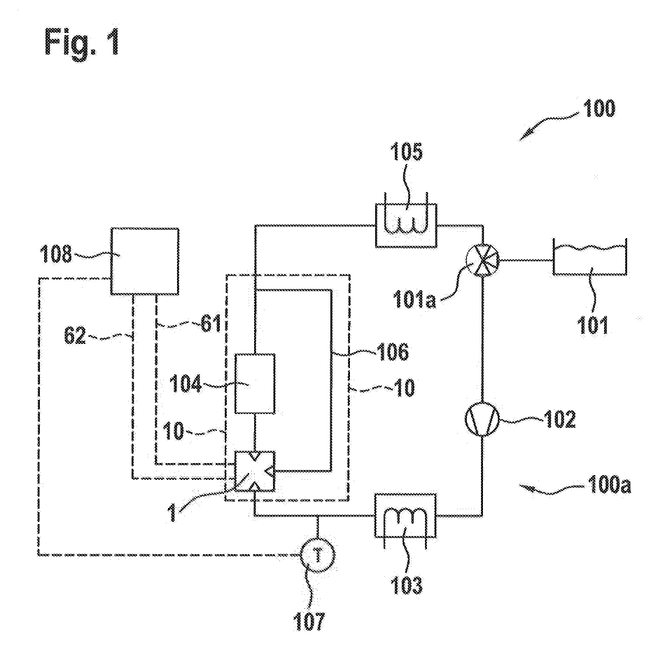

FIG. 1 schematically shows a waste-heat recovery system 100 of an internal combustion engine (not illustrated), with only the regions of importance being illustrated.

The waste-heat recovery system 100 has a circuit 100a which conducts a working medium and which, in a flow direction of the working medium, comprises a feed fluid pump 102, an evaporator 103, an expander unit 10 and a condenser 105. The expander unit 10 has a bypass valve 1 and has an expansion machine 104 and a bypass duct 106 connected in parallel. The working medium can, as required, be fed via a branch line and a valve arrangement 101a from a collecting vessel 101 into the circuit 100a. Here, the collecting vessel 101 may alternatively also be incorporated into the circuit 100a.

The evaporator 103 is connected to an exhaust line of the internal combustion engine, that is to say utilizes the heat energy of the exhaust gas of the internal combustion engine.

The bypass line 106 is arranged parallel to the expansion machine 104. Depending on the operating state of the internal combustion engine and resulting values, for example temperatures, of the working medium, the working medium is supplied to the expansion machine 104 or is conducted past the expansion machine 104 through the bypass line 106. For example, a temperature sensor 107 is arranged downstream of the evaporator 103.

The temperature sensor 107 determines the temperature of the working medium downstream of the evaporator 103, or corresponding signals, and transmits these to a control unit 108. In a manner dependent on various data, such as for example the temperature of the working medium downstream of the evaporator 103, the control unit 108 actuates an actuator of the bypass valve 1 via the two electrical lines 61, 62.

The bypass valve 1 is switched such that the working medium is conducted either through the expansion machine 104 or through the bypass line 106. The mass flow of the working medium may also be split up, such that a part of the working medium is supplied to the expansion machine 104 and a further part is supplied to the bypass line 106. The bypass valve 1 comprises an electromagnetic actuator. Owing to the evaporated working medium upstream of the expansion machine 104, the components of the expander unit 10 are subjected to very high temperature loading. For the electromagnetic actuator in particular, there is thus a high risk with regard to a shortening of service life and with regard to functional impairment.

According to the invention, the bypass valve 1 thus has a cooling device for the electromagnetic actuator.

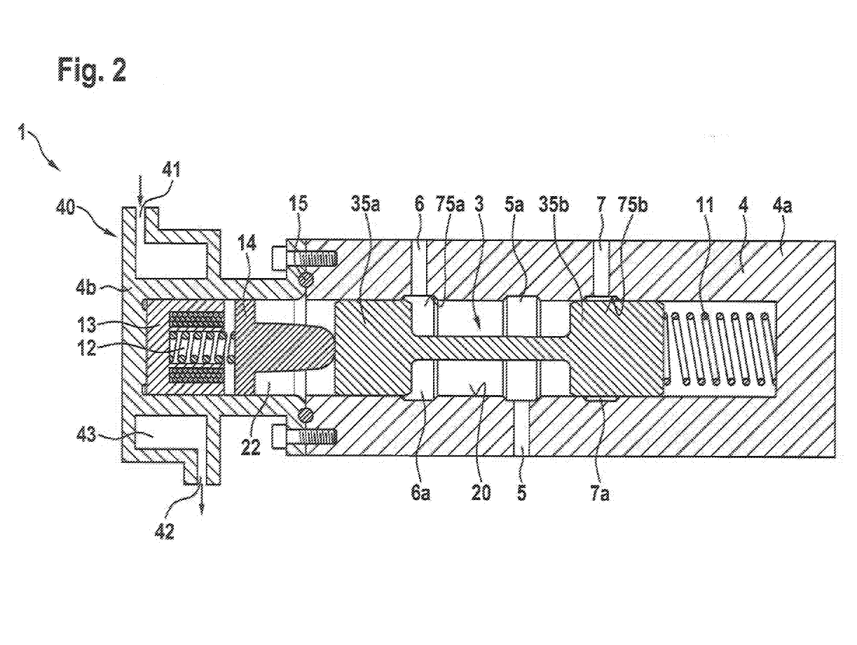

FIG. 2 schematically shows a bypass valve 1 in longitudinal section with a means for electromagnetic actuation of the bypass valve 1, with only the regions of importance being illustrated. In the embodiment of FIG. 2, the bypass valve 1 is designed as an outlet-controlled, proportional slide valve, though it is also possible, in alternative embodiments, for the bypass valve 1 to be of inlet-controlled configuration and/or to be designed as a seat valve, or to have a combination of a slide valve and a seat valve.

The bypass valve 1 comprises a valve housing 4 with a guide bore 20 formed therein. A slide 3 is arranged in longitudinally movable fashion in the guide bore 20. An inlet duct 5 with a ring-shaped inlet groove 5a, an outlet duct 6 with a ring-shaped outlet groove 6a, and a further outlet duct 7 with a further ring-shaped outlet groove 7a are formed in the valve housing 4. In the axial direction, the ring-shaped inlet groove 5a is arranged between the two ring-shaped outlet grooves 6a, 7a. Alternatively to this, it is also possible for the inlet duct 5 to be formed at a face side, that is to say in an axial direction, for example by way of a bore in the slide 3.

The evaporator 103 is arranged upstream of the inlet duct 5. The expansion machine 104 is arranged downstream of the outlet duct 6. The bypass duct 106 is arranged downstream of the further outlet duct 7.

A closing body 35a is formed on one end of the slide 3, and a further closing body 35b is formed on the opposite end of the slide 3. The two closing bodies 35a, 35b form in each case one slide seat 75a, 75b with the guide bore 20 formed in the valve housing 4. Here, the closing body 35a interacts with the outlet duct 6 and, together therewith, forms the slide seat 75a for the purposes of opening and closing the outlet duct 6 and correspondingly opening and closing a first hydraulic connection from the inlet duct 5 to the outlet duct 6. At the same time, the further closing body 35b interacts in the opposite sense with the further outlet duct 7 and, together therewith, forms the further slide seat 75b for the purposes of opening and closing the further outlet duct 7 and correspondingly opening and closing a second hydraulic connection from the inlet duct 5 to the further outlet duct 7. That is to say, when the throughflow cross section through the first hydraulic connection is increased in size by way of the stroke of the slide 3, the throughflow cross section through the second hydraulic connection is reduced in size to the same extent, and vice versa.

In the central position of the slide 3—that is to say in the position in which both outlet ducts 6, 7 are open—the two closing bodies 35a, 35b of the slide 3 can partially but not completely cover the two outlet ducts 6, 7. In this position, the first hydraulic connection and the second hydraulic connection are open to the same extent, such that the mass flows into the outlet duct 6—or to the expansion machine 104—and into the further outlet duct 7—or into the bypass duct 106—are of equal magnitude.

In a first end position of the slide 3, the closing body 35a completely or partially covers the slide seat 75a and thus completely or partially closes the first hydraulic connection, and in a second end position of the slide 3, the further closing body 35b completely or partially closes the further slide seat 75b and thus completely or partially closes the second hydraulic connection. The entire mass flow, or a major part, for example 85% to 95%, of the mass flow of the working medium is then conducted through the respective other hydraulic connection.

In the exemplary embodiment of FIG. 2, the bypass valve 1 is arranged in a two-part valve housing 4 with a first housing part 4a and a second housing part 4b. Here, the guide bore 20 is formed in the first housing part 4a, such that the slide 3 is guided in longitudinally movable fashion in the first housing part 4a. The first housing part 4a is screwed to the second housing part 4b with the interposition of a housing seal 15. An electromagnetic actuator 13 with a magnet coil is arranged in the second housing part 4b. An armature 14 is arranged, so as to adjoin the actuator 13 in the axial direction, in longitudinally movable fashion in an armature chamber 22 formed in the valve housing 4. The armature 14 is pushed away from the actuator 13 by an armature spring 12. The armature spring 12 is in this case arranged in a bore formed in the actuator 13.

The armature 14 interacts with the slide 3, in this specific embodiment with the closing body 35a of the slide 3. A bracing spring 11 is arranged in the first housing part 4a at that side of the slide 3 which is situated opposite the armature 14, which bracing spring also interacts with the slide 3, in the specific embodiment of FIG. 2 with the further closing body 35b. The bracing spring 11 acts counter to the armature spring 12, such that the slide 3 is braced between said two springs 11, 12.

When the actuator 13 is energized, said actuator attracts the armature 14 counter to the spring force of the armature spring 12, such that the bracing spring 11 can displace the slide 3 in the direction of the actuator 13. The bypass valve 1 is then situated in a position as illustrated in FIG. 2. The closing body 35a opens up the outlet duct 6, and the further closing body 35b covers the further slide seat 75b and thus closes the further outlet duct 7. In this end position, the first hydraulic connection to the expansion machine 104 is open, and the second hydraulic connection into the bypass duct 106 is closed.

If the energization of the actuator 13 is ended, the armature spring 12 pushes the slide 3 in a direction away from the actuator 13 counter to the spring force of the bracing spring 11.

The closing body 35a then covers the slide seat 75a and thus closes the outlet duct 6, and the further closing body 35b opens up the further outlet duct 7. In this opposite end position, the first hydraulic connection is closed, and the second hydraulic connection is open.

By way of specific configurations of the two springs 11, 12, for example also as progressive springs, and by way of variation of the actuator force of the actuator 13 based on the change in intensity of the energization, it is also possible for the slide 3 to be moved into any desired intermediate positions. In this way, the bypass valve 3 can be used as a proportional mass flow divider for the two outlet ducts 6, 7.

According to the invention, the bypass valve 1 has a cooling device 40. The cooling device 40 is preferably arranged so as to radially surround the actuator. In the exemplary embodiment of FIG. 2, the cooling device 40 is arranged in the second housing part 4b. The cooling device 40 comprises a cooling inlet 41, a cooling outlet 42 and a cooling chamber 43 arranged therebetween. Cooling medium, for example also cooled working medium of the circuit 100a, is supplied to the cooling device 40 through the cooling inlet 41, subsequently washes around the actuator 13 by flowing through the cooling chamber 43, and exits the cooling device 40 through the cooling outlet 42.

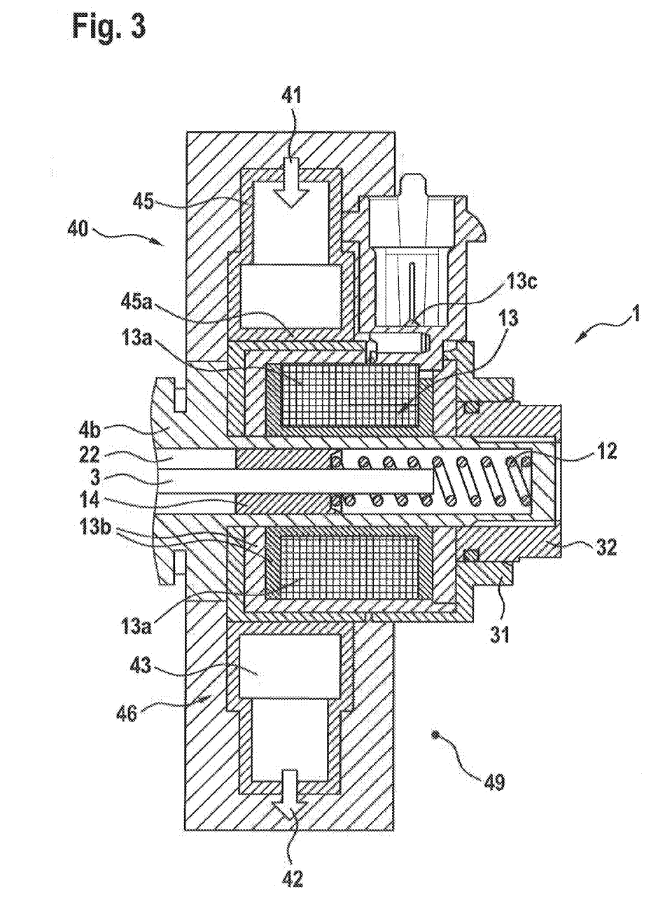

FIG. 3 shows a detail of the bypass valve 1 in the region of the cooling device 40, with only the regions of importance being illustrated. Here, in the region that is not illustrated, the bypass valve 1 has the inlet duct 5, the two outlet ducts 6, 7 and the slide 3 similarly to the embodiment of FIG. 2. In the embodiment of FIG. 3, the armature 14 is in the form of a solenoid plunger and is fixedly connected to the slide 3, for example by being pressed onto said slide. In the illustration of FIG. 3, the actuator 13, when energized, exerts a force on the armature, which force pushes said armature to the right, whereas the spring force of the armature spring 12 acts toward the left.

The armature chamber 22 is formed in the second housing part 4b, which is preferably formed from a non-magnetic material. The actuator 13 is arranged, so as to surround the second housing part 4b, in an actuator housing 31. The actuator housing 31 is fixed with respect to the valve housing 4 by way of a clamping device 32. The actuator housing 31 and clamping device 32 may, in refinements, also be formed in one piece.

The actuator 13 is of electromagnetic design and has a magnet coil 13a, a two-part magnet core 13b and an electrical terminal 13c. The electrical terminal 13c is in this case connected to the electrical lines 61, 62 of the control unit 108.

The cooling device 40 has a cooling housing 45, which may also be of multi-part form. The cooling housing 45 surrounds the actuator housing 31 with the actuator 13. The cooling housing 45 and actuator housing 31 may also, in refinements, be formed in one piece. The flow geometries of the cooling device 40, that is to say cooling inlet 41, cooling outlet 42 and cooling chamber 43, are formed in the cooling housing 45. In advantageous embodiments, the cooling housing 45 has a casing 46 which is either fixedly connected to, or formed integrally with, the cooling housing 45. The casing 46 is preferably formed from an insulation material, such that the cooling medium in the interior of the casing 46 is thermally insulated with respect to the surroundings 49. This is advantageous if, during the operation of the expander unit 10, the temperature of the casing 46 is at a lower temperature than the surroundings 49. Thus, an additional introduction of heat from the surroundings 49 into the casing 46 and further into the cooling medium is prevented.

Furthermore, the cooling housing 45 has a partition 45a which separates the actuator 13, or the actuator housing 31, from the cooling chamber 43 in medium-tight fashion. The actuator 13 is thus not exposed to the working medium, which may be highly aggressive. The partition 45a is advantageously formed from a non-magnetic material, such that it does not cause any impairment of the magnetic field of the actuator 13.

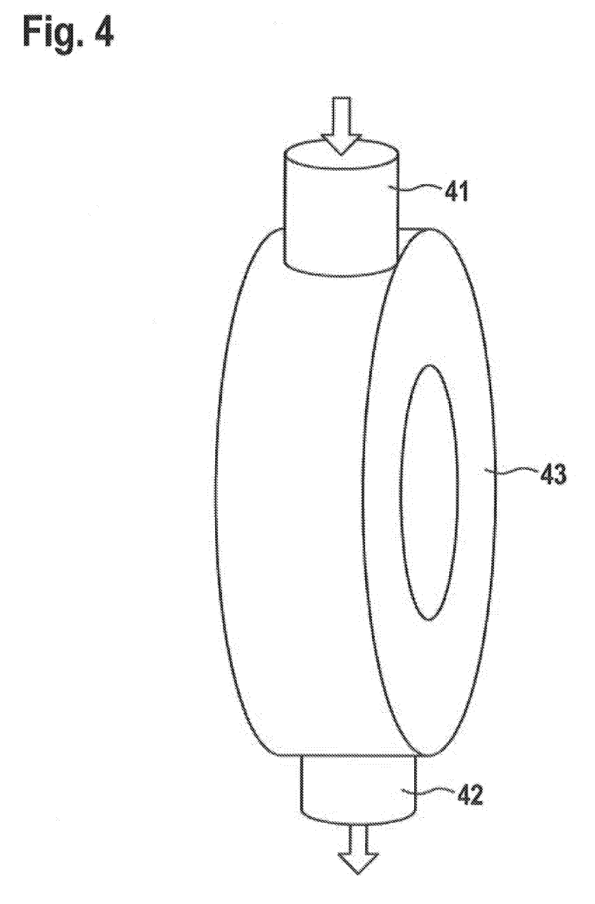

FIG. 4 shows the negative geometry of the cooling device 40 in the embodiment of FIG. 3, that is to say the form of the flow of the cooling medium through the cooling device 40. The cooling inlet 41 and cooling outlet 42 are in the form of bores, and the cooling chamber 43 is of ring-shaped form.

What is claimed is:

1. A bypass valve (1) having a valve housing (4) and having a slide (3) which is longitudinally movable in the valve housing (4), wherein an inlet duct (5), an outlet duct (6) and a further outlet duct (7) are formed in the valve housing (4), wherein a closing body (35a) of the slide (3) interacts, by longitudinal movement, with a slide seat (75a) formed in the valve housing (4) and thereby opens and closes a first hydraulic connection between the inlet duct (5) and the outlet duct (6), wherein a further closing body (35b) of the slide (3) interacts, by longitudinal movement, with a further slide seat (75b) formed in the valve housing (4) and thereby opens and closes a second hydraulic connection between the inlet duct (5) and the further outlet duct (7), wherein the longitudinal movement of the slide (3) is controlled by an electromagnetic actuator (13), characterized in that the bypass valve (1) has a cooling device (40) for cooling the actuator (13).

2. The bypass valve (1) according to claim 1, characterized in that the cooling device (40) has a cooling housing (45), wherein a cooling inlet (41), a cooling outlet (42) and a cooling chamber (43) are formed in the cooling housing (45).

3. The bypass valve (1) according to claim 2, characterized in that the cooling chamber (43) is arranged so as to radially surround the actuator (13).

4. The bypass valve (1) according to claim 2, characterized in that the cooling housing (45) has a partition (45a), wherein the partition (45a) separates the actuator (13) from the cooling chamber (43) in medium-tight fashion.

5. The bypass valve (1) according to claim 4, characterized in that the partition is formed from a non-magnetic material.

6. The bypass valve (1) according to claim 2, characterized in that the cooling housing (45) has a casing (46), wherein the casing (46) surrounds the cooling chamber (43), and wherein the casing (46) is formed from a thermal insulation material.

7. An expander unit (10) having an expansion machine (104), having a bypass line (106) and having a bypass valve (1) according to claim 1, wherein the bypass line (106) is arranged parallel to the expansion machine (104), wherein the bypass valve (1) controls the mass flow of a working medium to the expansion machine (104) and to the bypass line (106).

8. A waste-heat recovery system (100) having a circuit (100a) which conducts a working medium, wherein the circuit (100a) comprises, in a flow direction of the working medium, a pump (102), an evaporator (103), an expander unit (10) according to claim 7 and a condenser (105).
